(19) United States
(12) Patent Application Publication
(10) Pub. No.: US 2004/0035645 A1
(43) Pub. Date: Feb. 26, 2004

(54) Elevator

(76) Inventor: Jaakko Orrmann, Helsinki (FI)

Correspondence Address: BIRCH STEWART KOLASCH & BIRCH, PO BOX 747, FALLS CHURCH, VA, 22040-0747, US

(21) Appl. No.: 10/602,719

(22) Filed: Jun. 25, 2003

Related U.S. Application Data
(63) Continuation of application No. PCT/FI02/00054, filed on Jan. 23, 2002.

(30) Foreign Application Priority Data
Jan. 25, 2001 (FI) U20010038

(51) Int. Cl. B66B 11/08

(52) U.S. Cl. 187/266; 187/254

(57) ABSTRACT

An elevator comprising car guide rails (15) disposed in the vertical direction of an elevator shaft on the same side of the car (8), an elevator car moving along the car guide rails, counterweight guide rails (16) placed in the elevator shaft, a counterweight (13) moving along the counterweight guide rails. In addition, the elevator comprises a number of diverting pulleys and a traction sheave driven by a drive motor and mounted in the upper part of the shaft for the transmission of hoisting power, which are disposed in the elevator shaft on the same side of the car, a drive motor (1) arranged to drive one of the diverting pulleys, and a rope system. The traction sheave (2, 9) and at least two diverting pulleys are mounted in the upper part of the elevator shaft. The elevator car (8) and the counterweight (13) are provided with at least one diverting pulley each. Both the car and the counterweight have a suspension ratio of 3:1 or greater.

The present invention relates to an elevator as defined in the preamble of claim 1.

In prior art, Finnish patent application FI 990152 presents a traction sheave elevator with a diverting pulley mounted on a lateral side of the elevator car. Its car guide rails and counterweight guide rails are disposed in the elevator shaft on the same side of the elevator car. The elevator comprises a counterweight, an overhead rope pulley mounted on a fixed overhead structure in the upper part of the elevator shaft, a car rope pulley connected to the elevator car, a counterweight rope pulley connected to the counterweight, a drive motor arranged in the elevator shaft to drive one of the rope pulleys. Moreover, the elevator comprises a rope with a first end attached to the fixed overhead structure in the upper part of the elevator shaft on the same side of the elevator car as the car and counterweight guide rails, from where the rope is passed over the counterweight rope pulley, overhead rope pulley and car rope pulley, the second end of the rope being fastened to the fixed overhead structure. The structure according to the specification is implemented using a 2:1 suspension ratio.

When elevators are constructed in old buildings, it is necessary to consider the limitations associated with the spaces needed above and below the elevator in respect of the building space required, as well as the additional costs involved. If there is not enough space above the elevator, it may be impossible to place rope pulleys on top of the car.

The object of the invention is to disclose a new type of rope elevator suspension solution for a rucksack-type structure that takes up as little space as possible in the transverse direction of the shaft so as to allow a maximally effective utilization of the elevator shaft space. A further object of the invention is to disclose a rope elevator suspension solution for elevators to be installed in a confined space and elevators to be operated at a low speed, such as e.g. those designed for disabled persons.

The invention is characterized by what is presented in the characterization part of claim 1. Other embodiments of the invention are characterized by what is presented in the other claims.

The invention provides the advantage of allowing the elevator to be constructed in as compact a form as possible in respect of utilization of the cross-sectional area of the shaft. By employing the suspension solution of the invention in the elevator, it will be possible to hoist a big load with a smaller machine. The structure of the invention allows a slim machine and counterweight construction in the depthwise direction of the shaft, thus allowing effective utilization of shaft space in the widthwise direction. By mounting the machine in a position parallel to a shaft wall, no unused space is formed in the shaft due to an oblique position of the machine. By using the preferable suspension ratio of 4:1, a low car speed is produced with a reasonable number of revolutions of the machine and using a small machine, the rope speed thus equaling four times the speed of the elevator car. The rope suspension alternative of the invention is easy to install in different ways, the suspension lay-out is clear.

A low car speed is also produced by using a 3:1 rope suspension ratio, in which case the car speed is equal to one third of the rope speed on the motor circumference. By using a 3:1 suspension ratio, the space required by the elevator in the transverse direction of the shaft can be reduced because the rope pulleys for the suspension of the car and counterweight are placed side by side in the same plane at a side wall of the shaft. The most essential advantage of the actual rope suspension is achieved when it is technically advantageous to use a relatively high rotational speed of the machine relative to the nominal speed. In other words, the advantage is greatest if a low nominal car speed is needed, as in elevators for disabled persons and in freight elevators. It is advantageous to reduce the speed via the rope arrangement of the elevator.

In the following, the invention will be described in detail with reference to the attached drawings.

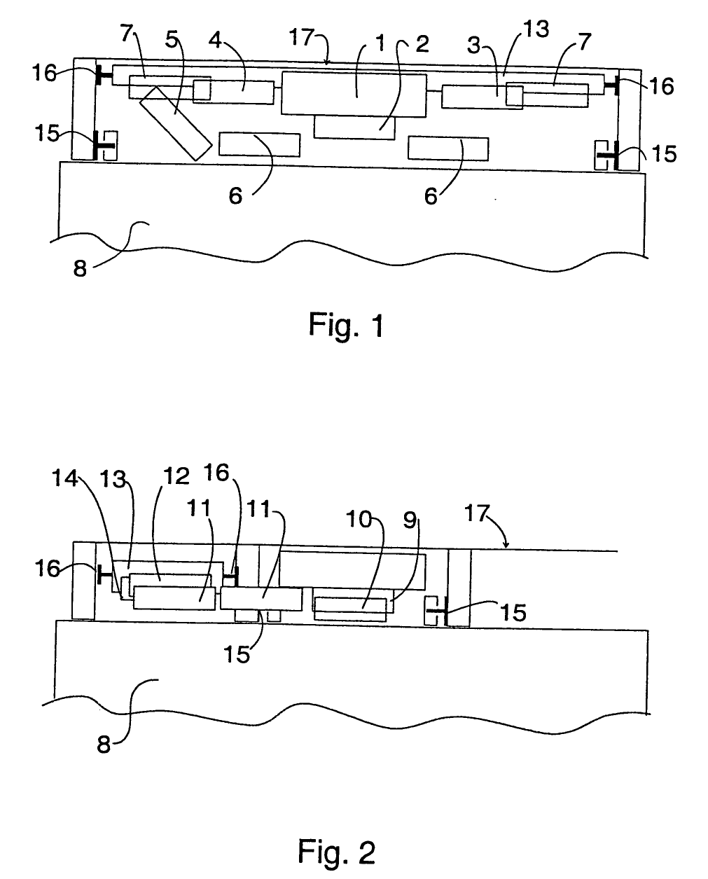

FIG. 1 presents an embodiment of the invention for the suspension of an elevator as seen from above.

FIG. 2 presents another embodiment of the invention for the suspension of an elevator as seen from above.

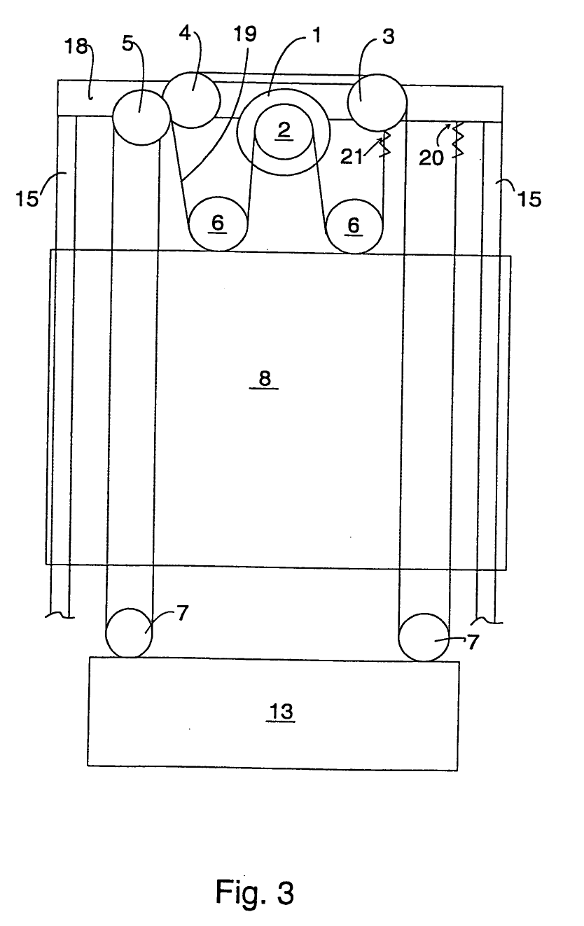

FIG. 3 presents the solution of FIG. 1 in front view.

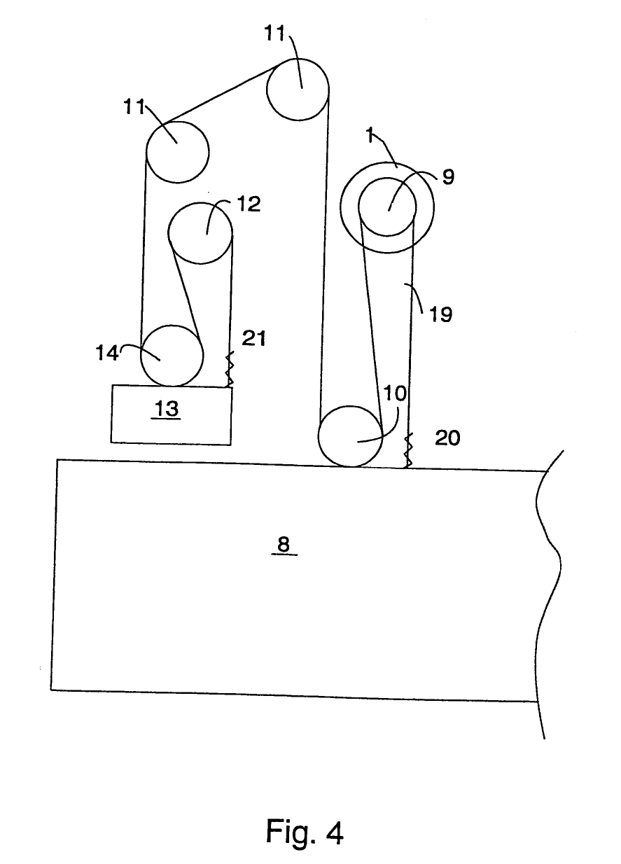

FIG. 4 presents the solution of FIG. 2 in front view.

FIG. 1 shows a top view of a traction sheave elevator in which the suspension of the elevator car is implemented on the so-called rucksack principle. The car guide rails 15 are arranged vertically in the shaft and the car 8 is designed to be movable along the guide rails. The counterweight guide rails 16 for guiding the counterweight 13 are placed vertically in the shaft. The counterweight guide rails are placed on the same side of the elevator car 8 as the car guide rails 15. The counterweight guide rails and the car guide rails are mounted side by side parallel to each other on the side of the car facing towards the wall 17. The counterweight guide rails are placed on the side of the wall. The drive motor 1 is supported by a transverse overhead structure 18 (FIG. 3) of the shaft. The traction sheave 2 of the motor 1 is connected to the motor. The fixed diverting pulleys 3 and 4 of the elevator are mounted on the fixed overhead structure 18 (FIG. 3). The diverting pulleys 6 of the car are attached to a load-bearing structure of the car 8 on the same side as the car guide rails. The diverting pulleys 7 of the counterweight are attached to a load-bearing structure of the counterweight 13. An overhead diverting pulley 5 is mounted on the fixed overhead structure 18 of the shaft and its plane of rotation is at a certain angle relative to the wall 17. The fixed overhead structure of the elevator bears the forces in the shaft.

FIG. 2 presents another embodiment of the invention. The figure shows a diagrammatic top view of a traction sheave elevator. The car guide rails 15 are arranged vertically in the shaft and the car 8 is arranged to be movable along them. The counterweight guide rails 16 for guiding the counterweight 13 are located in the shaft on the same side of the elevator car 8 as the car guide rails 15, but they are placed on one side of the machine, so the width of the counterweight does not occupy the whole shaft width. The drive motor 1 is mounted on an overhead structure of the shaft. The traction sheave 9 of the motor 1 is connected to the motor. The planes of rotation of a fixed diverting pulley 10 of the car, two fixed diverting pulleys 11, a diverting pulley 12 mounted on the fixed overhead structure and a diverting pulley 14 of the counterweight 13 are all in the same plane and are oriented in the shaft in a direction parallel to the wall 17.

FIG. 3 shows a front view of the solution presented in FIG. 1. The rope 19 is passed over the diverting pulleys as follows. The first end 20 of the rope is attached to the fixed overhead structure 18, from where it passes under one of the counterweight diverting pulleys 7, then via the fixed diverting pulleys 3 and 4 on the fixed overhead structure, passing over the drive motor 1, to the other counterweight diverting pulley 7, from where the rope 19 is further passed via the overhead diverting pulley 5 to one of the diverting pulleys 6 of the car and then via the traction sheave 2 of the motor to the other diverting pulley 6 of the car, from which the second end 21 of the rope goes to the fixed overhead structure 18, to which it is fastened. The rope 19 may also comprise a plurality of ropes.

FIG. 4 shows a front view of the solution presented in FIG. 2. The rope 19 has been arranged to run over the diverting pulleys as follows. The first end 20 of the rope is fixed to the load-bearing structure of the car 8, from which it is passed over the diverting pulley 9 of the motor 1 to and under a diverting pulley 10 fixed to the car 8 and further via fixed diverting pulleys 11 mounted on the shaft structure to and under a diverting pulley 14 fixed to the load-bearing structure of the counterweight 13, from where the rope goes further over an overhead diverting pulley 12 and is fastened to the load-bearing structure of the counterweight 13.

The invention is not limited to the examples of its embodiments described above; instead, many variations are possible within the inventive idea defined in the claims.

1. Elevator comprising car guide rails (15) disposed in the vertical direction of an elevator shaft on the same side of the car (8), an elevator car whose motion is guided by the car guide rails, counterweight guide rails (16) placed in the elevator shaft, a counterweight (13) whose motion is guided by the counterweight guide rails, a number of diverting pulleys and a traction sheave driven by a drive motor and mounted in the upper part of the shaft for the transmission of hoisting power, which are disposed in the elevator shaft on the same side of the car, a drive motor (1) arranged to drive one of said diverting pulleys, and a rope system, characterized in that the traction sheave (2, 9) and at least two diverting pulleys are mounted in the upper part of the elevator shaft and the elevator car (8) and the counterweight (13) are provided with at least one diverting pulley each and both the car and the counterweight have a suspension ratio of 3:1 or greater.

9. Elevator as defined in claim 1, characterized in that the traction sheave (2) and three diverting pulleys (3, 4, 5) are mounted in the upper part of the elevator shaft, the counterweight (13) is provided with two diverting pulleys (7) for supporting it, the car (8) is provided with two diverting pulleys (6) for supporting it, both the car (8) and the counterweight (13) having a suspension ratio of 4:1.

3. Elevator as defined in claim 2, characterized in that the plane of rotation of the diverting pulley (5) mounted on the fixed overhead structure of the elevator shaft is at an angle relative to a wall (17) of the elevator shaft.

4. Elevator as defined in claim 2 or 3, characterized in that the planes of rotation of diverting pulleys (3, 4, 6, 7) are parallel to the wall (17).

5. Elevator as defined in claim 1, characterized in that the traction sheave (9) and three diverting pulleys (11-12) are mounted in the upper part of the elevator shaft, the counterweight (13) is provided with one diverting pulley (14), the car (8) is provided with one diverting pulley (10), both the car and the counterweight having a suspension ratio of 3:1.

6. Elevator as defined in claim 5, characterized in that all the diverting pulleys are in the same plane.

7. Elevator as defined in claim 1, characterized in that the hoisting machine and the guide rails are disposed in the elevator shaft on a lateral side of the car on the same side of it.

8. Elevator as defined in claim 1, characterized in that the counterweight guide rails and the car guide rails are disposed in the elevator shaft on the same side of the elevator car.
